(19) United States
(12) Patent Application Publication
(10) Pub. No.: US 2022/0394938 A1
(43) Pub. Date: Dec. 15, 2022

(54) VACATION MODE FOR AN INDOOR GARDENING APPLIANCE

(71) Applicant: Haier US Appliance Solutions, Inc., Wilmington, DE (US)

(72) Inventors: Louis A. Wantland, Louisville, KY (US); Matthew R. Hunter, Louisville, KY (US); Brian Allgeier, Louisville, KY (US)

(21) Appl. No.: 17/345,313

(22) Filed: Jun. 11, 2021

(51) Int. Cl. A01G 9/24; A01G 9/02; A01G 7/04; G05B 15/02

(52) U.S. Cl. CPC A01G 9/249; A01G 9/247; A01G 9/246; A01G 9/023; A01G 7/045; G05B 15/02

(57) ABSTRACT

An indoor gardening appliance includes a grow module positioned within a grow chamber for receiving one or more plant pods. The indoor gardening system includes a sealed system and an air circulation system for conditioning air within the grow chamber, a hydration system for selectively hydrating plants, and a lighting system for providing growth lighting. A controller is configured to detect a vacation condition corresponding to a period of decreased usage of the indoor gardening appliance, e.g., based on a user command or period of inactivity, and adjust at least one operating parameter of the indoor gardening appliance in response to detecting the vacation condition, e.g., to reduce energy consumption, conserve water, and slow plant growth.

### FIELD OF THE INVENTION

The present subject matter relates generally to systems for gardening plants indoors, and more particularly, to systems and methods for implementing a vacation mode for an indoor gardening appliance.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow.

Conventional indoor garden centers facilitate continuous growth cycles by constant operation of hydration, lighting, and nutrition systems according to predetermined schedules. However, there may be times when it is desirable to adjust the speed of the plant growth, e.g., such as when a user goes on vacation or does not otherwise need to harvest plants from the appliance for a period of time. Conventional indoor garden centers provide little versatility of operation in such situations. In addition, conventional indoor garden centers fail to adapt to the particular schedules of each user.

Accordingly, an improved indoor garden center would be useful. More particularly, an indoor garden center and associated methods of operation for adjusting plant growth rate to conserve energy, reduce water usage, or otherwise improve appliance performance and user satisfaction would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, an indoor gardening appliance is provided including a liner positioned within a cabinet and defining a grow chamber, a grow module mounted within the liner and defining a plurality of apertures for receiving one or more plant pods, and a controller configured to detect a vacation condition corresponding to a period of decreased usage of the indoor gardening appliance and adjust at least one operating parameter of the indoor gardening appliance in response to detecting the vacation condition.

In another exemplary embodiment, a method of operating an indoor gardening appliance is provided. The indoor gardening appliance includes a liner positioned within a cabinet and defining a grow chamber. The method includes detecting a vacation condition corresponding to a period of decreased usage of the indoor gardening appliance and adjust at least one operating parameter of the indoor gardening appliance in response to detecting the vacation condition.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gardening appliance according to an exemplary embodiment of the present subject matter.

FIG. 2 depicts a front view of the exemplary gardening appliance of FIG. 1 with the doors open according to an exemplary embodiment of the present subject matter.

FIG. 3 is a cross sectional view of the exemplary gardening appliance of FIG. 1, taken along Line 3-3 from FIG. 2 with an internal divider removed for clarity.

FIG. 4 is a top perspective view of the exemplary gardening appliance of FIG. 1, with the top panel of the cabinet removed to reveal a rotatable grow module according to an exemplary embodiment of the present subject matter.

FIG. 5 provides a perspective cross sectional view of the exemplary gardening appliance of FIG. 1 according to another exemplary embodiment of the present subject matter.

FIG. 6 provides a perspective view of the grow module of the exemplary gardening appliance of FIG. 1 according to another exemplary embodiment of the present subject matter.

FIG. 7 provides a perspective cross sectional view of the exemplary grow module of FIG. 6 according to another exemplary embodiment of the present subject matter.

FIG. 8 provides a top cross-sectional view of the exemplary grow module of FIG. 6 according to another exemplary embodiment of the present subject matter.

FIG. 9 provides a schematic view of an air circulation system that may be used with the exemplary gardening appliance of FIG. 1 according to an exemplary embodiment of the present subject matter.

FIG. 10 provides a flow chart illustrating a method of operating a gardening appliance in a vacation mode in accordance with example embodiments of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “approximately,” “substantially,” or “about,” refer to being within a ten percent (10%) margin of error of the stated value. Moreover, as used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

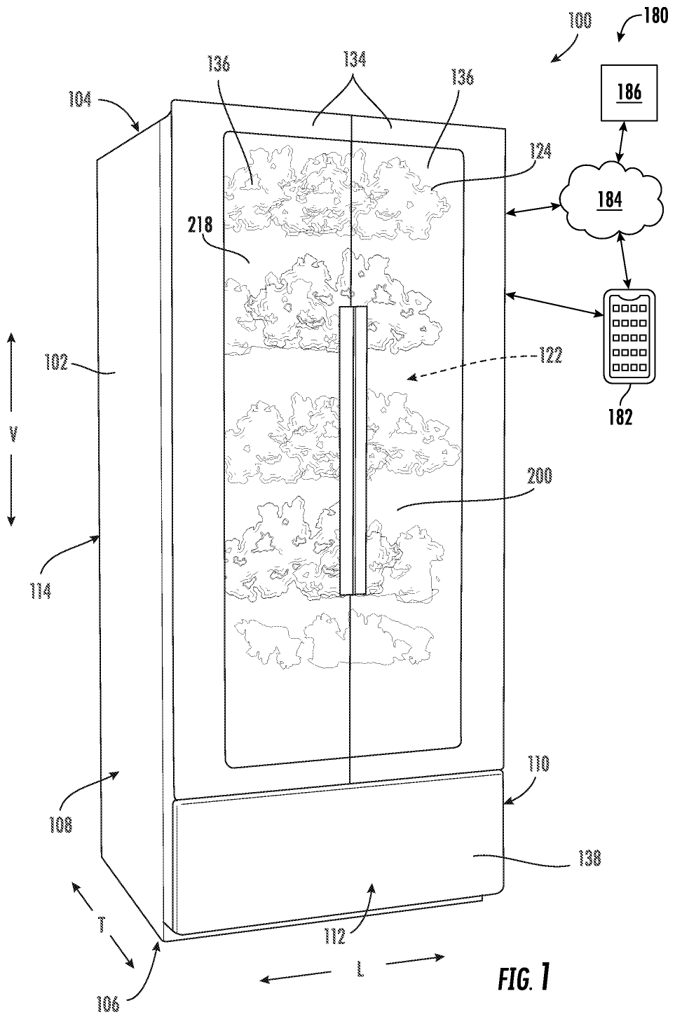

FIG. 1 provides a front view of a gardening appliance 100 according to an exemplary embodiment of the present subject matter. According to exemplary embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

Gardening appliance 100 includes a housing or cabinet 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another and form an orthogonal direction system.

Gardening appliance 100 may include an insulated liner 120 positioned within cabinet 102. Liner 120 may at least partially define a temperature controlled chamber, referred to herein generally as a grow chamber 122, within which plants 124 may be grown. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter.

Cabinet 102, or more specifically, liner 120 may define a substantially enclosed back region or portion 130. In addition, cabinet 102 and liner 120 may define a front opening, referred to herein as front display opening 132, through which a user of gardening appliance 100 may access grow chamber 122, e.g., for harvesting, planting, pruning, or otherwise interacting with plants 124. According to an exemplary embodiment, enclosed back portion 130 may be defined as a portion of liner 120 that defines grow chamber 122 proximate rear side 114 of cabinet 102. In addition, front display opening 132 may generally be positioned proximate or coincide with front side 112 of cabinet 102.

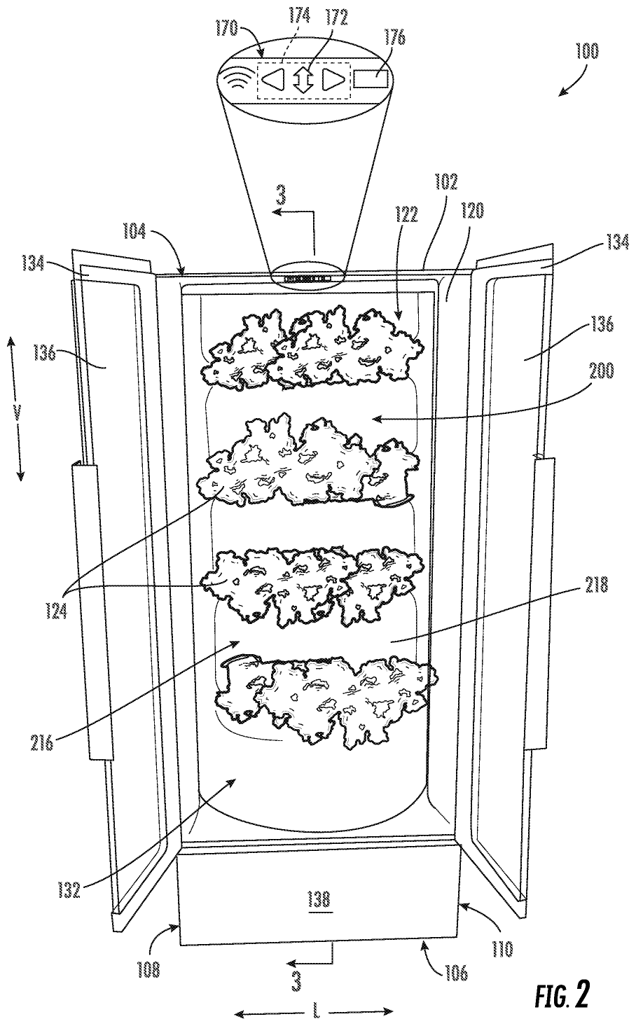

Gardening appliance 100 may further include one or more doors 134 that are rotatably mounted to cabinet 102 for providing selective access to grow chamber 122. For example, FIG. 1 illustrates doors 134 in the closed position such that they may help insulate grow chamber 122. By contrast, FIG. 2 illustrates doors 134 in the open positioned for accessing grow chamber 122 and plants 124 stored therein. Doors 134 may further include a transparent window 136 through which a user may observe plants 124 without opening doors 134.

Although doors 134 are illustrated as being rectangular and being mounted on front side 112 of cabinet 102 in FIGS. 1 and 2, it should be appreciated that according to alternative embodiments, doors 134 may have different shapes, mounting locations, etc. For example, doors 134 may be curved, may be formed entirely from glass, etc. In addition, doors 134 may have integral features for controlling light passing into and/or out of grow chamber 122, such as internal louvers, tinting, UV treatments, polarization, etc. One skilled in the art will appreciate that other chamber and door configurations are possible and within the scope of the present invention.

According to the illustrated embodiment, cabinet 102 further defines a drawer 138 positioned proximate bottom 106 of cabinet 102 and being slidably mounted to cabinet 102 for providing convenient storage for plant nutrients, system accessories, water filters, etc. In addition, behind drawer 138 is a mechanical compartment 140 for receipt of an environmental control system including a sealed system for regulating the temperature within grow chamber 122, as described in more detail below.

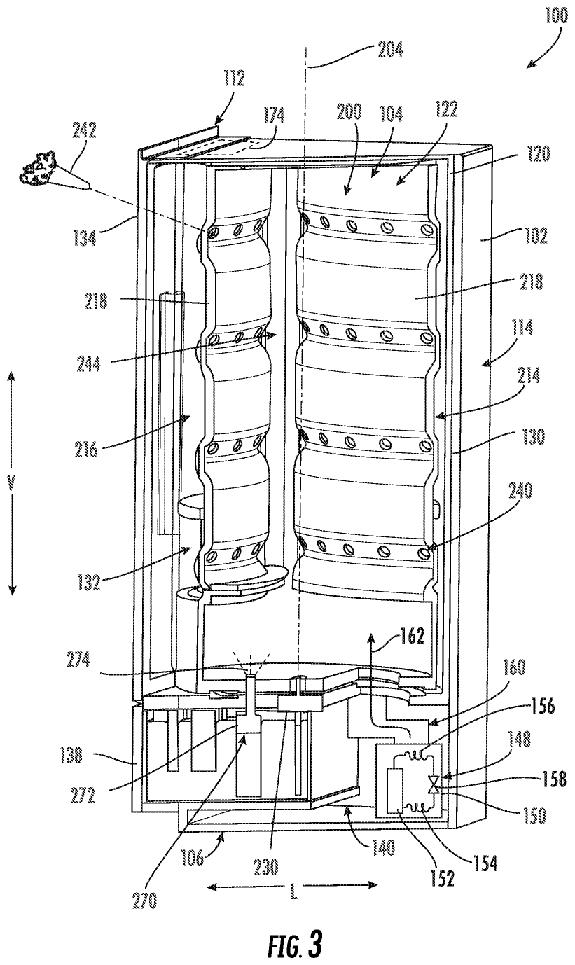

FIG. 3 provides a schematic view of certain components of an environmental control system 148 that may be used to regulate a temperature within grow chamber 122. Specifically, environmental control system 148 may include a sealed system 150, a duct system 160, and a hydration system 270, or any other suitable components or subsystems for regulating an environment within grow chamber 122, e.g., for facilitating improved or regulated growth of plants 124 positioned therein. Specifically, FIG. 3 illustrates sealed system 150 within mechanical compartment 140. Although an exemplary sealed system is illustrated and described herein, it should be appreciated that variations and modifications may be made to sealed system 150 while remaining within the scope of the present subject matter. For example, sealed system 150 may include additional or alternative components, different ducting configurations, etc.

As shown, sealed system 150 includes a compressor 152, a first heat exchanger or evaporator 154 and a second heat exchanger or condenser 156. As is generally understood, compressor 152 is generally operable to circulate or urge a flow of refrigerant through sealed system 150, which may include various conduits which may be utilized to flow refrigerant between the various components of sealed system 150. Thus, evaporator 154 and condenser 156 may be between and in fluid communication with each other and compressor 152.

During operation of sealed system 150, refrigerant flows from evaporator 154 and to compressor 152, and compressor 152 is generally configured to direct compressed refrigerant from compressor 152 to condenser 156. For example, refrigerant may exit evaporator 154 as a fluid in the form of a superheated vapor. Upon exiting evaporator 154, the refrigerant may enter compressor 152, which is operable to compress the refrigerant. Accordingly, the pressure and temperature of the refrigerant may be increased in compressor 152 such that the refrigerant becomes a more superheated vapor.

Condenser 156 is disposed downstream of compressor 152 and is operable to reject heat from the refrigerant. For example, the superheated vapor from compressor 152 may enter condenser 156 and transfer energy to air surrounding condenser 156 (e.g., to create a flow of heated air). In this manner, the refrigerant condenses into a saturated liquid and/or liquid vapor mixture. A condenser fan (not shown) may be positioned adjacent condenser 156 and may facilitate or urge the flow of heated air across the coils of condenser 156 (e.g., from ambient atmosphere) in order to facilitate heat transfer.

According to the illustrated embodiment, an expansion device or a variable electronic expansion valve 158 may be further provided to regulate refrigerant expansion. During use, variable electronic expansion valve 158 may generally expand the refrigerant, lowering the pressure and temperature thereof. In this regard, refrigerant may exit condenser 156 in the form of high liquid quality/saturated liquid vapor mixture and travel through variable electronic expansion valve 158 before flowing through evaporator 154. Variable electronic expansion valve 158 is generally configured to be adjustable, e.g., such that the flow of refrigerant (e.g., volumetric flow rate in milliliters per second) through variable electronic expansion valve 158 may be selectively varied or adjusted.

Evaporator 154 is disposed downstream of variable electronic expansion valve 158 and is operable to heat refrigerant within evaporator 154, e.g., by absorbing thermal energy from air surrounding the evaporator (e.g., to create a flow of cooled air). For example, the liquid or liquid vapor mixture refrigerant from variable electronic expansion valve 158 may enter evaporator 154. Within evaporator 154, the refrigerant from variable electronic expansion valve 158 receives energy from the flow of cooled air and vaporizes into superheated vapor and/or high quality vapor mixture. An air handler or evaporator fan (not shown) is positioned adjacent evaporator 154 and may facilitate or urge the flow of cooled air across evaporator 154 in order to facilitate heat transfer. From evaporator 154, refrigerant may return to compressor 152 and the vapor-compression cycle may continue.

As explained above, environmental control system 148 includes a sealed system 150 for providing a flow of heated air or a flow cooled air throughout grow chamber 122 as needed. To direct this air, environmental control system 148 includes a duct system 160 for directing the flow of temperature regulated air, identified herein simply as flow of air 162 (see, e.g., FIG. 3). In this regard, for example, an evaporator fan can generate a flow of cooled air as the air passes over evaporator 154 and a condenser fan can generate a flow of heated air as the air passes over condenser 156.

These flows of air 162 are routed through a cooled air supply duct and/or a heated air supply duct (not shown), respectively. In this regard, it should be appreciated that environmental control system 148 may generally include a plurality of ducts, dampers, diverter assemblies, and/or air handlers to facilitate operation in a cooling mode, in a heating mode, in both a heating and cooling mode, or any other mode suitable for regulating the environment within grow chamber 122. It should be appreciated that duct system 160 may vary in complexity and may regulate the flows of air from sealed system 150 in any suitable arrangement through any suitable portion of grow chamber 122.

Gardening appliance 100 may include a control panel 170. Control panel 170 includes one or more input selectors 172, such as e.g., knobs, buttons, push buttons, touchscreen interfaces, etc. In addition, input selectors 172 may be used to specify or set various settings of gardening appliance 100, such as e.g., settings associated with operation of sealed system 150. Input selectors 172 may be in communication with a processing device or controller 174. Control signals generated in or by controller 174 operate gardening appliance 100 in response to input selectors 172. Additionally, control panel 170 may include a display 176, such as an indicator light or a screen. Display 176 is communicatively coupled with controller 174 and may display information in response to signals from controller 174. Further, as will be described herein, controller 174 may be communicatively coupled with other components of gardening appliance 100, such as e.g., one or more sensors, motors, or other components.

As used herein, “processing device” or “controller” may refer to one or more microprocessors or semiconductor devices and is not restricted necessarily to a single element. The processing device can be programmed to operate gardening appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

Referring again to FIG. 1, a schematic diagram of an external communication system 180 will be described according to an exemplary embodiment of the present subject matter. In general, external communication system 180 is configured for permitting interaction, data transfer, and other communications between gardening appliance 100 and one or more external devices. For example, this communication may be used to provide and receive operating parameters, user instructions or notifications, performance characteristics, user preferences, or any other suitable information for improved performance of gardening appliance 100. In addition, it should be appreciated that external communication system 180 may be used to transfer data or other information to improve performance of one or more external devices or appliances and/or improve user interaction with such devices.

For example, external communication system 180 permits controller 174 of gardening appliance 100 to communicate with a separate device external to gardening appliance 100, referred to generally herein as an external device 182. As described in more detail below, these communications may be facilitated using a wired or wireless connection, such as via a network 184. In general, external device 182 may be any suitable device separate from gardening appliance 100 that is configured to provide and/or receive communications, information, data, or commands from a user. In this regard, external device 182 may be, for example, a personal phone, a smartphone, a tablet, a laptop or personal computer, a wearable device, a smart home system, or another mobile or remote device.

In addition, a remote server 186 may be in communication with gardening appliance 100 and/or external device 182 through network 184. In this regard, for example, remote server 186 may be a cloud-based server 186, and is thus located at a distant location, such as in a separate state, country, etc. According to an exemplary embodiment, external device 182 may communicate with a remote server 186 over network 184, such as the Internet, to transmit/receive data or information, provide user inputs, receive user notifications or instructions, interact with or control gardening appliance 100, etc. In addition, external device 182 and remote server 186 may communicate with gardening appliance 100 to communicate similar information.

In general, communication between gardening appliance 100, external device 182, remote server 186, and/or other user devices or appliances may be carried using any type of wired or wireless connection and using any suitable type of communication network, non-limiting examples of which are provided below. For example, external device 182 may be in direct or indirect communication with gardening appliance 100 through any suitable wired or wireless communication connections or interfaces, such as network 184. For example, network 184 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 180 is described herein according to an exemplary embodiment of the present subject matter. However, it should be appreciated that the exemplary functions and configurations of external communication system 180 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

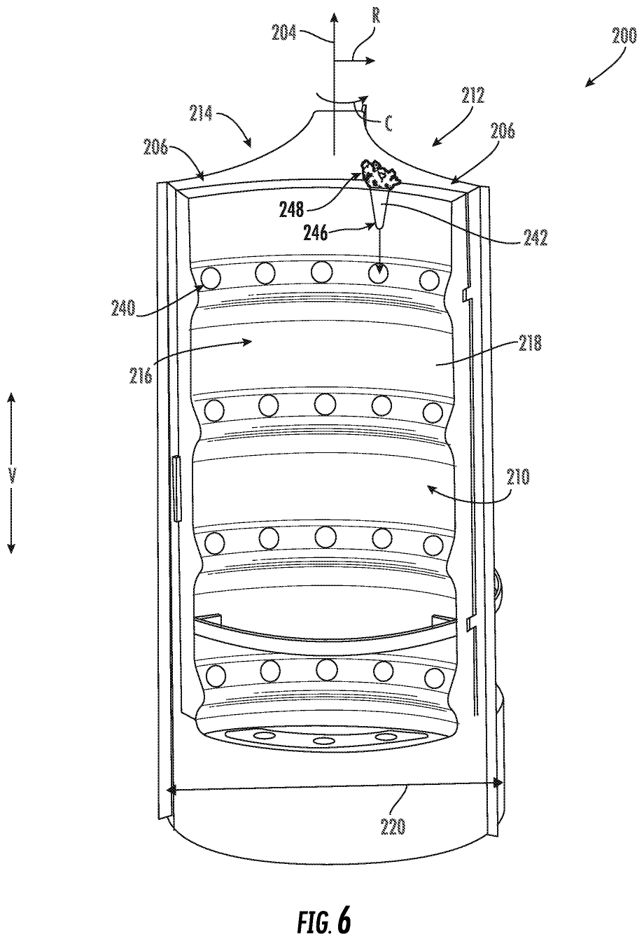

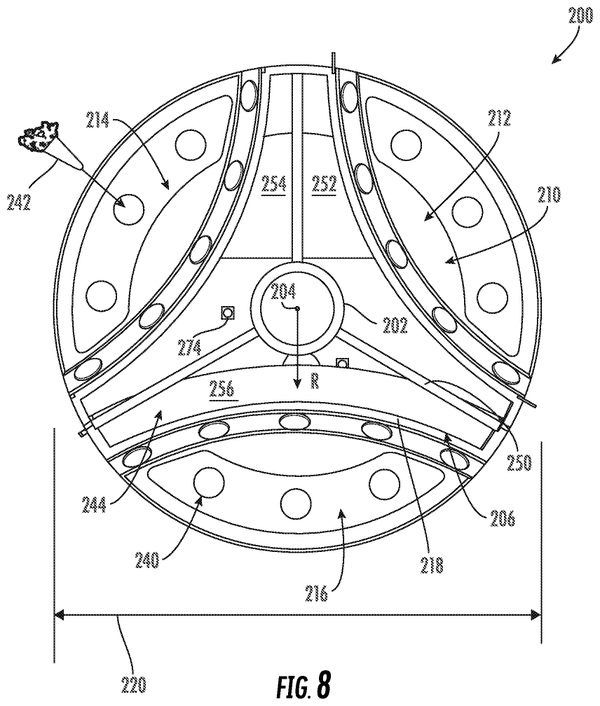

Referring now generally to FIGS. 1 through 8, gardening appliance 100 generally includes a rotatable carousel, referred to herein as a grow module 200 that is mounted within liner 120, e.g., such that it is within grow chamber 122. As illustrated, grow module 200 includes a central hub 202 that extends along and is rotatable about a central axis 204. Specifically, according to the illustrated embodiment, central axis 204 is parallel to the vertical direction V. However, it should be appreciated that central axis 204 could alternatively extend in any suitable direction, e.g., such as the horizontal direction. In this regard, grow module 200 generally defines an axial direction, i.e., parallel to central axis 204, a radial direction R that extends perpendicular to central axis 204, and a circumferential direction C that extends around central axis 204 (e.g. in a plane perpendicular to central axis 204).

Grow module 200 may further include a plurality of partitions 206 that extend from central hub 202 substantially along the radial direction R. In this manner, grow module 200 defines a plurality of chambers, referred to herein generally by reference numeral 210, by dividing or partitioning grow chamber 122. Referring specifically to a first embodiment of grow module 200 illustrated in FIGS. 1 through 8, grow module 200 includes three partitions 206 to define a first chamber 212, a second chamber 214, and a third chamber 216, which are circumferentially spaced relative to each other. In general, as grow module 200 is rotated within grow chamber 122, the plurality of chambers 210 define substantially separate and distinct growing environments, e.g., for growing plants 124 having different growth needs.

More specifically, partitions 206 may extend from central hub 202 to a location immediately adjacent liner 120. Although partitions 206 are described as extending along the radial direction, it should be appreciated that they need not be entirely radially extending. For example, according to the illustrated embodiment, the distal ends of each partition is joined with an adjacent partition using an arcuate wall 218, which is generally used to support plants 124.

Notably, it is desirable according to exemplary embodiments to form a substantial seal between partitions 206 and liner 120. Therefore, according to an exemplary embodiment, grow module 200 may define a grow module diameter 220 (e.g., defined by its substantially circular footprint formed in a horizontal plane). Similarly, enclosed back portion 130 of liner 120 may be substantially cylindrical and may define a liner diameter 222. In order to prevent a significant amount of air from escaping between partitions 206 and liner 120, liner diameter 222 may be substantially equal to or slightly larger than grow module diameter 220.

According to still other embodiments, grow module 200 may include one or more sealing elements 224 positioned on a radially distal end of each of partitions 206. In this regard, sealing elements 224 may extend from partitions 206 toward liner 120 to contact and seal against liner 120. For example, according to the illustrated embodiment, sealing elements 224 are wiper blades formed from silicone or another suitably resilient material. Thus, as grow module 200 rotates, sealing elements 224 slide against liner 120 to substantially seal each of the plurality of chambers 210. It should be appreciated that as used herein, the term “substantial seal” and the like is not intended to refer to a perfectly airtight junction. Instead, this term is generally used to refer to an environment which may be regulated independently of adjacent environments to a reasonable degree. For example, if plants 124 and the first chamber 212 prefer a 10° F. increase in temperature relative to plants 124 and second chamber 214, the substantial seal between these two chambers may facilitate such temperature difference.

Referring now specifically to FIG. 3, gardening appliance 100 may further include a motor 230 or another suitable driving element or device for selectively rotating grow module 200 during operation of gardening appliance 100. In this regard, according to the illustrated embodiment, motor 230 is positioned below grow module 200, e.g., within mechanical compartment 140, and is operably coupled to grow module 200 along central axis 204 for rotating grow module 200.

As used herein, “motor” may refer to any suitable drive motor and/or transmission assembly for rotating grow module 200. For example, motor 230 may be a brushless DC electric motor, a stepper motor, or any other suitable type or configuration of motor. For example, motor 230 may be an AC motor, an induction motor, a permanent magnet synchronous motor, or any other suitable type of AC motor. In addition, motor 230 may include any suitable transmission assemblies, clutch mechanisms, or other components.

According to an exemplary embodiment, motor 230 may be operably coupled to controller 174, which is programmed to rotate grow module 200 according to predetermined operating cycles, based on user inputs (e.g. via touch buttons 172), etc. In addition, controller 174 may be communicatively coupled to one or more sensors, such as temperature or humidity sensors, positioned within the various chambers 210 for measuring temperatures and/or humidity, respectively. Controller 174 may then operate motor 230 in order to maintain desired environmental conditions for each of the respective chambers 210. For example, as will be described in more detail below, gardening appliance 100 includes features for providing certain locations of gardening appliance 100 with light, temperature control, proper moisture, nutrients, and other requirements for suitable plant growth. Motor 230 may be used to position specific chambers 210 where needed to receive such growth requirements.

According to an exemplary embodiment, such as where three partitions 206 form three chambers 212-216, controller 174 may operate motor 230 to index grow module 200 sequentially through a number of preselected positions. More specifically, motor 230 may rotate grow module 200 in a counterclockwise direction (e.g. when viewed from a top of grow module 200) in 120° increments to move chambers 210 between sealed positions and display positions. As used herein, a chamber 210 is considered to be in a “sealed position” when that chamber 210 is substantially sealed between grow module 200 (i.e., central hub 202 and adjacent partitions 206) and liner 120. By contrast, a chamber 210 is considered to be in a “display position” when that chamber 210 is at least partially exposed to front display opening 132, such that a user may access plants 124 positioned within that chamber 210.

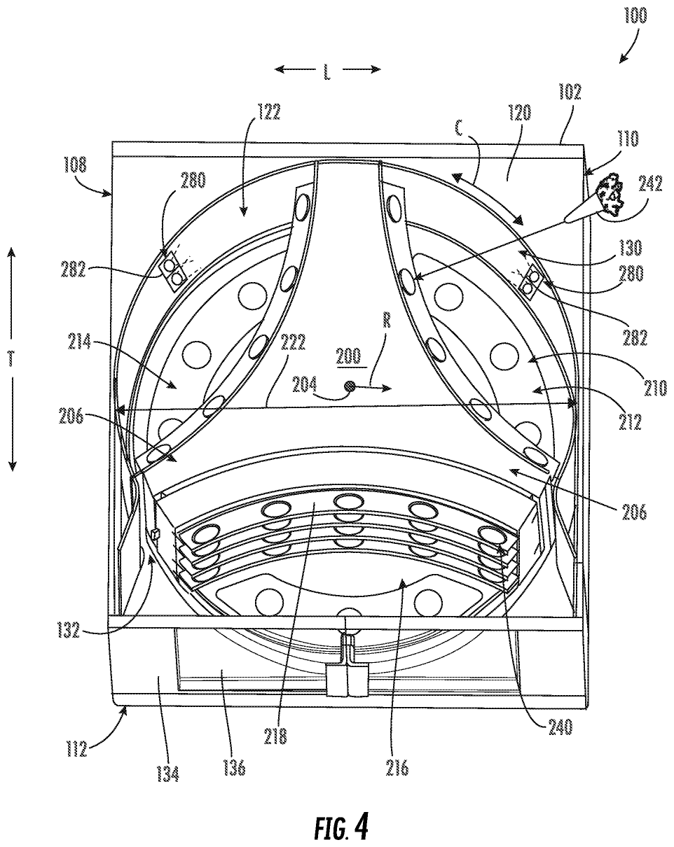

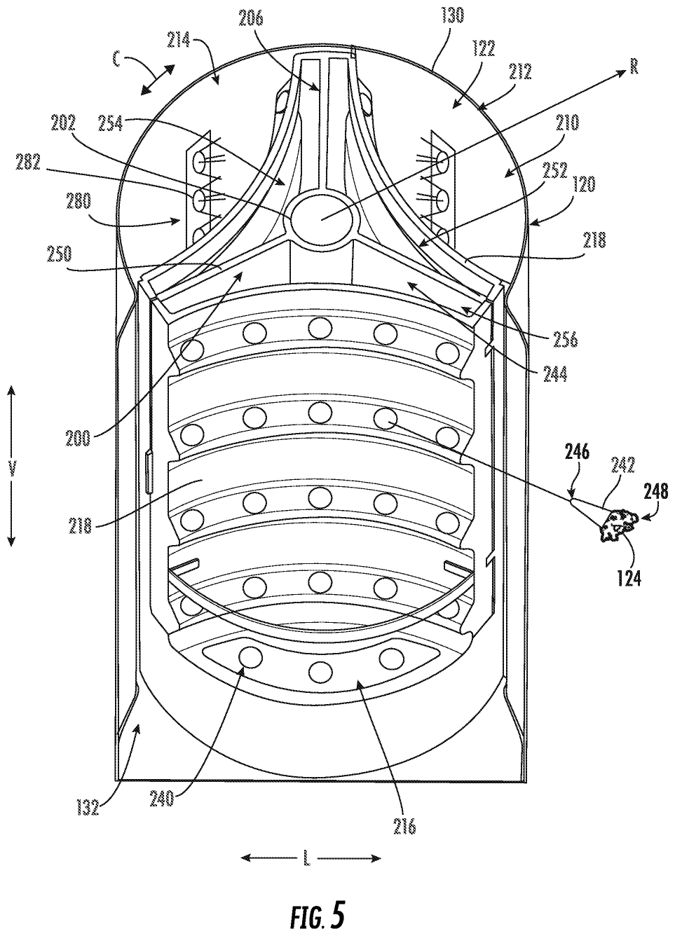

For example, as illustrated in FIGS. 4 and 5, first chamber 212 and second chamber 214 are both in a sealed position, whereas third chamber 216 is in a display position. As motor 230 rotates grow module 200 by 120 degrees in the counterclockwise direction, second chamber 214 will enter the display position, while first chamber 212 and third chamber 216 will be in the sealed positions. Motor 230 may continue to rotate grow module 200 in such increments to cycle grow chambers 210 between these sealed and display positions.

Referring now generally to FIGS. 4 through 8, grow module 200 will be described in more detail according to an exemplary embodiment of the present subject matter. As shown, grow module 200 defines a plurality of apertures 240 which are generally configured for receiving plant pods 242 into an internal root chamber 244. Plant pods 242 generally contain seedlings or other material for growing plants positioned within a mesh or other support structure through which roots of plants 124 may grow within grow module 200. A user may insert a portion of plant pod 242 (e.g., a seed end or root end 246) having the desired seeds through one of the plurality of apertures 240 into root chamber 244. A plant end 248 of the plant pod 242 may remain within grow chamber 210 such that plants 124 may grow from grow module 200 such that they are accessible by a user. In this regard, grow module 200 defines root chamber 244, e.g., within at least one of central hub 202 and the plurality of partitions 206. As will be explained below, water and other nutrients may be supplied to the root end 246 of plant pods 242 within root chamber 244. Notably, apertures 240 may be covered by a flat flapper seal (not shown) to prevent water from escaping root chamber 244 when no plant pod 242 is installed.

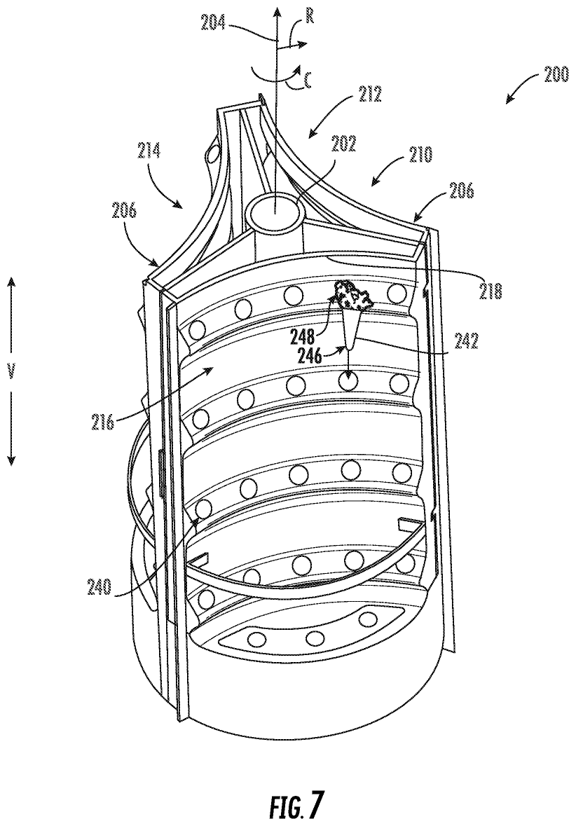

As best shown in FIGS. 5 and 7, grow module 200 may further include an internal divider 250 that is positioned within root chamber 244 to divide root chamber 244 into a plurality of root chambers, each of the plurality of root chambers being in fluid communication with one of the plurality of grow chambers 210 through the plurality of apertures 240. More specifically, according to the illustrated embodiment, internal divider 250 may divide root chamber 244 into a first root chamber 252, a second root chamber 254, and a third root chamber 256. According to an exemplary embodiment, first root chamber 252 may provide water and nutrients to plants 124 positioned in the first grow chamber 212, second root chamber 254 may provide water and nutrients to plants 124 positioned in the second grow chamber 214, and third root chamber 256 may provide water and nutrients to plants 124 positioned in the third grow chamber 216. In this manner, environmental control system 148 may control the temperature and/or humidity of each of the plurality of chambers 212-216 and the plurality of root chambers 252-256 independently of each other.

Environmental control system 148 may further include a hydration system 270 which is generally configured for providing water to plants 124 to support their growth. Specifically, according to the illustrated embodiment, hydration system 270 generally includes a water supply 272 and misting device 274 (e.g., such as a fine mist spray nozzle or nozzles). For example, water supply 272 may be a reservoir containing water (e.g., distilled water) or may be a direct connection municipal water supply. Misting device 274 may be positioned at a bottom of root chamber 244 and may be configured for charging root chamber 244 with mist for hydrating the roots of plants 124. Alternatively, misting devices 274 may pass through central hub 204 along the vertical direction V and periodically include a nozzle for spraying a mist or water into root chamber 244 or grow chamber 122. Because various plants 124 may require different amounts of water for desired growth, hydration system 270 may alternatively include a plurality of misting devices 274, e.g., all coupled to water supply 272, but being selectively operated to charge each of first root chamber 252, second root chamber 254, and third root chamber 256 independently of each other.

Notably, environmental control system 148 described above is generally configured for regulating the temperature and humidity (e.g., or some other suitable water level quantity or measurement) within one or all of the plurality of chambers 210 and/or root chambers 252-256 independently of each other. In this manner, a versatile and desirable growing environment may be obtained for each and every chamber 210.

Referring now for example to FIGS. 4 and 5, gardening appliance 100 may further include a light assembly 280 which is generally configured for providing light into selected grow chambers 210 to facilitate photosynthesis and growth of plants 124. As shown, light assembly 280 may include a plurality of light sources 282 stacked in an array, e.g., extending along the vertical direction V. For example, light sources 282 may be mounted directly to liner 120 within grow chamber 122, or may alternatively be positioned behind liner 120 such that light is projected through a transparent window or light pipe into grow chamber 122. The position, configuration, and type of light sources 282 described herein are not intended to limit the scope of the present subject matter in any manner.

Light sources 282 may be provided as any suitable number, type, position, and configuration of electrical light source(s), using any suitable light technology and illuminating in any suitable color. For example, according to the illustrated embodiment, light source 282 includes one or more light emitting diodes (LEDs), which may each illuminate in a single color (e.g., white LEDs), or which may each illuminate in multiple colors (e.g., multi-color or RGB LEDs) depending on the control signal from controller 174. According to exemplary embodiments, light sources 282 may include growth lights that are adjustable in intensity and can generate photosynthetic active radiation. In this regard, photosynthetically active radiation (PAR) generally refers to the waveband of light that plants use for photosynthesis. However, it should be appreciated that according to alternative embodiments, light sources 282 may include any other suitable traditional light bulbs or sources, such as halogen bulbs, fluorescent bulbs, incandescent bulbs, glow bars, a fiber light source, etc.

According to still other exemplary embodiments, light sources 282 may include ultraviolet lights to improve the health, robustness, or overall quality of plants 124 in gardening appliance 100. Specifically, according to the illustrated embodiment, light assembly 280 may include ultraviolet (UV) lights 282 or light boards that include ultraviolet lights. Notably, these UV lights 282 may generate ultraviolet light in the A- or B-spectrum. In this regard, controller 174 may be configured for selectively generating UVA light, UVB light, or some combination there between. In general, UVA and UVB light may be used to supplement standard grow lighting, e.g., to selectively slow the growth of plants 124.

According to an exemplary embodiment, light assembly 280 is positioned only within the enclosed back portion 130 of liner 120 such that only grow chambers 210 which are in a sealed position are exposed to light from light sources 282. Specifically, grow module 200 acts as a physical partition between light assemblies 280 and front display opening 132. In this manner, as illustrated in FIG. 5, no light may pass from first chamber 212 or second chamber 214 through grow module 200 and out front display opening 132. As grow module 200 rotates, two of the three grow chambers 210 will receive light from light assembly 280 at a time. According still other embodiments, a single light assembly may be used to reduce costs, whereby only a single grow chamber 210 will be lit at a single time.

Gardening appliance 100 and grow module 200 have been described above to explain an exemplary embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow module 200 having two partitions 206 extending from opposite sides of central hub 202 to define a first grow chamber and a second grow chamber. According to such an embodiment, by rotating grow module 200 by 180 degrees about central axis 206, the first chamber may alternate between the sealed position (e.g., facing rear side 114 of cabinet 102) and the display position (e.g., facing front side 112 of cabinet 102). By contrast, the same rotation will move the second chamber from the display position to the sealed position.

According to still other embodiments, gardening appliance 100 may include a three chamber grow module 200 but may have a modified cabinet 102 such that front display opening 132 is wider and two of the three grow chambers 210 are displayed at a single time. Thus, first chamber 212 may be in the sealed position, while second chamber 214 and third chamber 216 may be in the display positions. As grow module 200 is rotated counterclockwise, first chamber 212 is moved into the display position and third chamber 216 is moved into the sealed position.

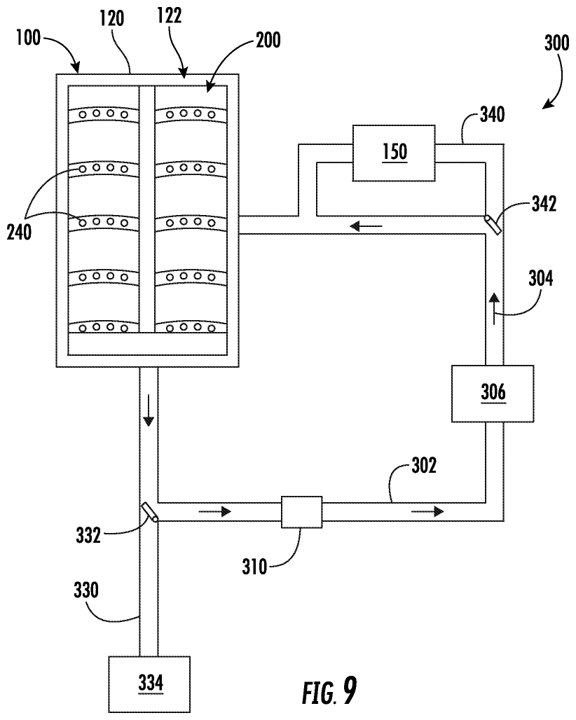

Referring now specifically to FIG. 9, an air circulation system 300 will be described according to an exemplary embodiment of the present subject matter. In general, air circulation system 300 may be used to regulate air quality characteristics of a flow of air within grow chamber 122. For example, continuing example from above, air circulation system 300 may be a part or subsystem of environmental control system 148 of gardening appliance 100. Although air circulation system 300 is described herein in the context of gardening appliance 100, it should be appreciated that aspects of the present subject matter may be used to regulate air quality characteristics in any other gardening appliance or in any other application where it is desirable to regulate characteristics of a flow of air.

In general, air circulation system 300 includes a recirculation duct 302 that is in fluid communication with grow chamber 122 for removing, supplying, or recirculating the flow of air (e.g., identified generally herein by reference numeral 304). In addition, air circulation system 300 includes a fan assembly 306 that is operably coupled to recirculation duct 302 for urging the flow of air 304 through recirculation duct 302. In general, the fan assembly 306 may be any flow regulating device that is configured for recirculating or urging a flow of air. For example, the fan assembly 302 may include one or more axial fans, centrifugal fans, etc. In addition, the fan assembly 306 may be positioned at any suitable location on recirculation duct 302 or otherwise in fluid communication with recirculation duct 302.

In general, air circulation system 300 may be generally configured for monitoring and/or regulating the temperature, humidity, gas concentrations, or other characteristics of the flow of air 304. In this regard, according to an exemplary embodiment, air circulation system 300 includes a sensing assembly 310 that is positioned within gardening appliance 100 for sensing these various quantitative or qualitative characteristics of flow of air 304. For example, sensing assembly may include temperature sensors, humidity sensors, flow meters, gas sensors, etc.

As used herein, “temperature sensor” or the equivalent is intended to refer to any suitable type of temperature measuring system or device positioned at any suitable location for measuring the desired temperature. Thus, for example, sensing assembly 310 may include a temperature sensor may be any suitable type of temperature sensor, such as a thermistor, a thermocouple, a resistance temperature detector, a semiconductor-based integrated circuit temperature sensors, etc. In addition, the temperature sensor may be positioned at any suitable location and may output a signal, such as a voltage, to a controller that is proportional to and/or indicative of the temperature being measured. Although exemplary positioning of temperature sensors is described herein, it should be appreciated that gardening appliance 100 may include any other suitable number, type, and position of temperature, humidity, and/or other sensors according to alternative embodiments.

As used herein, the terms “humidity sensor” or the equivalent may be intended to refer to any suitable type of humidity measuring system or device positioned at any suitable location for measuring the desired humidity. Thus, for example, “humidity sensor” may refer to any suitable type of humidity sensor, such as capacitive digital sensors, resistive sensors, and thermal conductivity humidity sensors. In addition, the humidity sensor may be positioned at any suitable location and may output a signal, such as a voltage, to a controller that is proportional to and/or indicative of the humidity being measured. Although exemplary positioning of humidity sensors is described herein, it should be appreciated that gardening appliance 100 may include any other suitable number, type, and position of humidity sensors according to alternative embodiments.

In order to monitor the concentration or level of a particular gas or gases within the flow of air 304, sensing assembly 310 may include a gas sensor that is positioned within the flow of air 304. For example, the gas sensor may include one or more non-dispersive infrared sensors, photoacoustic sensors, electrochemical sensors, or metal-oxide semiconductor sensors. For example, the gas sensor may be positioned within recirculation duct 302, though any other suitable position of the gas sensor may be used according to alternative embodiments. For example, sensing assembly 310 may be positioned within grow chamber 122 or at any other suitable location within gardening appliance 100. A controller, such as controller 174 of gardening appliance 100, may be in operative communication with the fan assembly 306, sensing assembly 310, and other portions of gardening appliance 100 to monitor and/or regulate gas concentrations of the flow of air 304. Specifically, for example, controller 174 may obtain a concentration of a particular gas, such as carbon dioxide or ethaline, using the gas sensor. Controller 174 may then operate fan assembly 306, sealed system 150, or other system components to adjust the concentration of ethaline within the flow of air 304. It should be appreciated that according to alternative embodiments, sensing assembly 310 may monitor any other suitable gas concentrations or flow characteristics.

As noted above, air circulation system 300 may be a subsystem or a part of environmental control system 148 of gardening appliance 100. Thus, air circulation system 300 may include other features for manipulating other flow characteristics, drawing in air or a particular gas from another source, discharging air, etc. For example, gardening appliance 100 may further include a vent duct 330 that is in fluid communication with grow chamber 122. As illustrated, vent duct 330 is fluidly coupled to recirculation duct 302 just upstream of sensing assembly 310. In addition, a vent damper 332 may be operably coupled to vent duct 330 for selectively routing the flow of air 304 through a vent duct 330.

According to the illustrated embodiment, vent duct 330 is fluidly coupled to the ambient environment 334 in this manner, air circulation system 300 or indoor gardening appliance 100 may periodically discharge some or all air from within grow chamber 122. In addition, vent damper 332 may be moved to an intermediate position to recirculate some air while permitting the rest of the air to flow to ambient environment 334. Although vent duct 330 is described herein as being used to discharge air from grow chamber. It should be appreciated that according to alternative embodiments, vent duct 330 may be used to draw in fresh air, and indoor gardening appliance 100 may further include any suitable fan assemblies or flow regulating devices for achieving such an inflow of fresh air.

In addition, recirculation duct 302 may be fluidly coupled to a sealed system duct 340 for selectively diverting some or all of the flow of air 304 through a sealed system. In this regard, as explained above, gardening appliance 100 may include a sealed system 150 for regulating the temperature, humidity, or other flow characteristics of air within grow chamber 122. According to the illustrated embodiment, air circulation system 300 includes a sealed system damper 342 for selectively coupling recirculation duct 304 with sealed system duct 340, such that the flow of air 304 passes through sealed system 150. In this manner, indoor gardening appliance 100 may regulate any suitable characteristics of the flow of air 304, such as temperature, humidity, etc. It should be appreciated that air circulation system 300 may have different duct systems, flow regulation devices, reactive assemblies, air supply sources, and other features while remaining within the scope of the present subject matter.

Now that the construction of gardening appliance 100 has been described, an exemplary method 400 of operating a gardening appliance will be described. Although the discussion below refers to the exemplary method 400 of operating gardening appliance 100, one skilled in the art will appreciate that the exemplary method 400 is applicable to the operation of a variety of other gardening appliances or for use in any suitable application. In exemplary embodiments, the various method steps as disclosed herein may be performed by controller 174 or a separate, dedicated controller. As explained below, method 400 is generally directed to operating a gardening appliance, such as gardening appliance 100, according to a vacation mode or cycle.

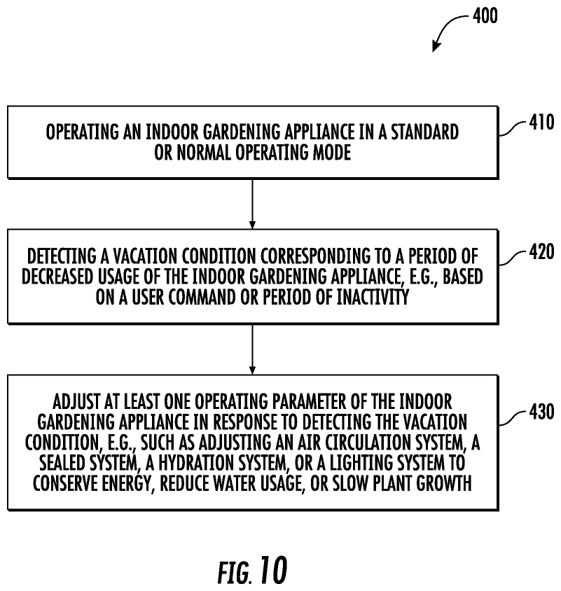

Referring now to FIG. 10, method 400 includes, at step 410, operating a gardening appliance 100 in a standard or normal operating mode. In this regard, the normal operating mode may refer operation of gardening appliance 100 outside of, or not during, the vacation mode. For example, during the normal operating mode, gardening appliance 100 and all of its subsystems (e.g., environmental control system 148, sealed system 150, hydration system 270, light assembly 280, air circulation system 300, and/or other subsystems) may all operate normally to facilitate healthy growth of plants 124.

Method 400 further includes, at step 420, detecting a vacation condition corresponding to a period of decreased usage of the indoor gardening appliance. For example, the vacation condition may be detected or identified based on a user command. In this regard, a user may press a button on control panel 170 to initiate a vacation mode. Alternatively, a user may use control panel 170 to input a date and time at which indoor gardening appliance 100 should commence a vacation mode. According to still other embodiments, a user may interact with indoor gardening appliance 100 using external device 182, such as a mobile phone, to initiate or schedule the initiation of the vacation mode.

According to still other embodiments, the vacation mode may be automatically initiated by controller 174 upon a predetermined period of inactivity. For example, controller 174 may be programmed by the manufacturer or the user to enter into the vacation mode if the predetermined amount of time has passed since the user last interacted with indoor gardening appliance 100. For example, “user interaction” may include touching control panel 170, opening the door 134, connecting to the appliance using external device 182, or otherwise interacting with indoor gardening appliance 100 in any manner. The predetermined period of time may vary and may be manipulated by user. According to exemplary embodiments, the predetermined period of time is between about 1 day and 10 days, between about 3 days and 7 days, or about 4 days. It should be appreciated that other inactivity periods may be set while remaining within the scope of the present subject matter. Further, it should be appreciated that indoor gardening appliance 100 may communicate with external device 182 (e.g., via push notification) to seek confirmation prior to initiation of the vacation mode.

Step 430 includes adjusting at least one operating parameter of the gardening appliance in response to detecting the vacation condition. As used herein, an “operating parameter” of gardening appliance 100 is any cycle setting, operating time, compressor speed, fan speed, part configuration, or other operating characteristic that may affect the performance of gardening appliance 100. Thus, references to operating parameter adjustments or “adjusting at least one operating parameter” are intended to refer to control actions intended to affect system performance to meet the plant's needs during the vacation mode.

In general, the at least one operating parameter may be adjusted to facilitate at least one of the conservation of energy, the reduction of water usage, or the adjustment of a growth rate of plants within the grow chamber. Exemplary system adjustments will be described below, such as adjusting an air circulation system, a sealed system, a hydration system, a lighting system, etc. However, it should be appreciated that these are only exemplary operating parameter adjustments and that controller 174 may be programmed to perform any other suitable adjustments to the operation of indoor gardening appliance 100 during the vacation mode while remaining within scope the present subject matter.

According to exemplary embodiments, adjusting the at least one operating parameter may include regulating a concentration of a particular gas in grow chamber 122 using air circulation system 300. For example, according to exemplary embodiments, air circulation system may regulate the concentration of ethaline gas within grow chamber 122 in a manner that helps to reduce plant growth during the vacation mode. For example, air circulation system 300 may use sensing assembly 310 to monitor the concentration of ethaline gas and may vent indoor air to the ambient environment 334 or may draw in ambient air from the ambient environment 334 to regulate the concentration of this gas. It should be appreciated that other gas concentrations may be monitored and regulated the same as above.

In addition, according to exemplary embodiments, adjusting the at least one operating parameter may include using the sealed system to adjust the temperature within grow chamber 122. For example, sealed system 150 may be operated to lower a chamber temperature of grow chamber 122, e.g., to slow the photosynthesis process and decrease the growth rate of plants 124. In addition, air circulation system 300 may operate to discharge heated air from grow chamber 122 or cool air from ambient environment 334 to help adjust the chamber temperature. Similarly, sealed system 150 and air circulation system 300 may operate together to ensure a suitable humidity within grow chamber 122.

In addition, adjusting the at least one operating parameter may include adjusting light assembly 280 and light sources 282 to manipulate the growth light received by plants 124. For example, according to exemplary embodiments, light assembly 280 may adjust a wavelength of the growth light that is generated by a light assembly. In this regard, for example, light assembly 280 may increase the amount of blue spectrum light directed to plants 124. In addition, adjusting the at least one operating parameter may include decreasing a light intensity of photosynthetic active radiation growth light, e.g., decreasing the PAR experienced by plants 124 to slow photosynthesis. According to still other embodiments, light assembly 280 may generate ultraviolet light in the UVA range, UVB range, or both, as this may result in slower plant growth.

According to still other embodiments, adjusting the at least one operating parameter may include adjusting the operation of hydration system 270. In this regard, the standard operating cycle may include a standard hydration schedule. This standard hydration schedule may include time intervals between misting cycles, flowrates of water during misting cycles, and the duration of misting cycles. According to exemplary embodiments, adjusting the at least one operating parameter may include increasing a time between hydration cycles relative to the standard hydration cycle. In this regard, if the time interval between misting cycles in a standard operating cycle is 4 or 5 minutes, step 430 may include increasing the time between hydration cycles to 6 or 7 minutes. In addition, the flow rate discharge from hydration system 270 may be adjusted. For example, adjusting the at least one operating parameter may include decreasing a flow rate of a flow of liquid relative to the flow rate discharged during a standard hydration mode.

Notably, this decreased hydration may help conserve energy, reduce water usage, and slow plant growth. However, it may be undesirable to let grow chamber 120 to become to dry as this may be harmful to the overall health of plants 124. Accordingly, step 430 of adjusting the at least one operating parameter may include adjusting a chamber humidity (e.g., using sealed system 150 and/or air circulation system 300) to compensate for the lower hydration rate generated by hydration system 270. For example, air circulation system 300 may open the damper 332 to draw in more moisture from the ambient environment 334 and sealed system 150 may remove less moisture from the flow of air 304.

Although the description above refers to the adjustment of operating parameters that affect the entire grow chamber 122, it should be appreciated that plants 124 within different chambers of indoor gardening appliance (e.g., such as chamber 212-216) may have different growth characteristics and requirements during the vacation mode. Accordingly, it should be appreciated that aspects of the present subject matter and are intended to include independent control of the environment within each chamber 212-216 during the vacation mode. In other words, step 430 may include adjusting at least one operating parameter only within a selected subset of a plurality of grow chambers.

FIG. 10 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 400 are explained using gardening appliance 100 as an example, it should be appreciated that these methods may be applied to the operation of any suitable gardening appliance.

Aspects of the present subject matter are generally directed to an indoor gardening appliance that may implement a vacation mode and/or otherwise adapt to the user's lifestyle. For example, the exemplary indoor gardening appliance may adjust its operation and key growing conditions to affect the growth rate of plants, e.g., to pause or slow the growing of plants during a user's vacation. Although the present disclosure discusses exemplary operating parameters that may be adjusted to affect growth rate, it should be appreciated that these parameters and adjustments are only exemplary and are not intended to limit the scope of the present subject matter in any manner.

Exemplary adjustments may include manipulations related to the growth light applied to the plants by a lighting assembly. For example, the lighting assembly may shift the wavelength or intensity of the applied light. This may include lowering the light intensity or duration. This may include reducing the photosynthetic active radiation (PAR) growth light, e.g., by a set percentage or to a specific power level. In addition, the lighting assembly may generate blue light or light within the blue wavelength spectrum. In the same manner, the lighting assembly may energize one or more ultraviolet lights, such as UVA and UVB lights, which may be applied at the same time as the reduction in PAR grow lighting.

In addition, aspects of the present construction may include using minimal insulation at certain portions surrounding liner 120 or defining heat escape pathways around the liner to permit evacuation of heat generated within the grow chamber, e.g., by grow lighting. In general, lowering the temperature may help slow growth by lowering the rate that the plants can both metabolize and photosynthesize. An environmental control system may also adjust the concentration of various gases within grow chamber that might affect the growth rate, such as ethaline gas.

In addition, aspects of the present subject matter may include minimizing the water usage of the indoor garden center, e.g., by increasing the time between misting sprays. For example, if the plant roots were misted once every 5 minutes, this misting interval could be extended to every 6 minutes in the vacation mode. In addition, the duration of each misting cycle may be adjusted. According to exemplary embodiments, to account for this change in available moisture, the indoor gardening appliance may increase the humidity around in the grow chamber (e.g., by balancing the temperature and humidity) to pull less moisture from the plants growing therein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An indoor gardening appliance, comprising:
a liner positioned within a cabinet and defining a grow chamber;
a grow module mounted within the liner and defining a plurality of apertures for receiving one or more plant pods; and
a controller configured to:
detect a vacation condition corresponding to a period of decreased usage of the indoor gardening appliance; and
adjust at least one operating parameter of the indoor gardening appliance in response to detecting the vacation condition.

2. The indoor gardening appliance of claim 1, wherein detecting the vacation condition comprises:
receiving a user command to enter a vacation mode.

3. The indoor gardening appliance of claim 2, further comprising:
a user interface panel, wherein the user command to enter the vacation mode is selected by a user through the user interface panel.

4. The indoor gardening appliance of claim 2, wherein the controller is in operative communication with a remote device through an external network, and wherein the user command to enter the vacation mode is provided through the remote device.

5. The indoor gardening appliance of claim 1, wherein detecting the vacation condition comprises:
determining that a predetermined amount of time has passed since a user last interacted with the indoor gardening appliance.

6. The indoor gardening appliance of claim 5, wherein the predetermined amount of time is between about 3 days and 7 days.

7. The indoor gardening appliance of claim 1, wherein adjusting the at least one operating parameter facilitates at least one of the conservation of energy, the reduction of water usage, or the adjustment of a growth rate of plants within the grow chamber.

8. The indoor gardening appliance of claim 1, further comprising an air circulation system, wherein adjusting the at least one operating parameter comprises:
regulating a concentration of ethaline gas in the grow chamber using the air circulation system.

9. The indoor gardening appliance of claim 1, further comprising a sealed system, wherein adjusting the at least one operating parameter comprises:
lowering a chamber temperature of the grow chamber using the sealed system.

10. The indoor gardening appliance of claim 1, further comprising a light assembly, wherein adjusting the at least one operating parameter comprises:
adjusting a wavelength of growth light generated by the light assembly.

11. The indoor gardening appliance of claim 1, further comprising a light assembly, wherein adjusting the at least one operating parameter comprises:
decreasing a light intensity of photosynthetic active radiation growth light.

12. The indoor gardening appliance of claim 1, further comprising a light assembly comprising ultraviolet light sources, wherein adjusting the at least one operating parameter comprises:
generating ultraviolet light using the ultraviolet light sources.

13. The indoor gardening appliance of claim 1, further comprising an air circulation system, wherein adjusting the at least one operating parameter comprises:
discharging heat from the grow chamber using the air circulation system.

14. The indoor gardening appliance of claim 1, further comprising a hydration system for selectively implementing hydration cycles to provide water to plants to support growth, wherein adjusting the at least one operating parameter comprises:
increasing a time between the hydration cycles relative to a standard hydration schedule.

15. The indoor gardening appliance of claim 1, further comprising a hydration system for selectively implementing hydration cycles to provide water to plants to support growth, wherein adjusting the at least one operating parameter comprises:
decreasing a flow rate of a flow of liquid during a hydration cycle.

16. The indoor gardening appliance of claim 1, further comprising a sealed system, wherein adjusting the at least one operating parameter comprises:
adjusting a chamber humidity to compensate for a lower hydration rate using the sealed system.

17. The indoor gardening appliance of claim 1, further comprising an air circulation system, wherein adjusting the at least one operating parameter comprises:
opening a vent damper of the air circulation system to draw in ambient air to generate more moisture.

18. The indoor gardening appliance of claim 1, wherein the grow chamber is divided into a plurality of grow chambers, and wherein the at least one operating parameter is adjusted only within a selected subset of the plurality of grow chambers.

19. A method of operating an indoor gardening appliance, the indoor gardening appliance comprising a liner positioned within a cabinet and defining a grow chamber, the method comprising:
detecting a vacation condition corresponding to a period of decreased usage of the indoor gardening appliance; and
adjust at least one operating parameter of the indoor gardening appliance in response to detecting the vacation condition.

20. The method of claim 19, wherein adjusting the at least one operating parameter facilitates at least one of the conservation of energy, the reduction of water usage, or the adjustment of a growth rate of plants within the grow chamber.
